(19) United States
(12) Patent Application Publication
(10) Pub. No.: US 2025/0039768 A1
(43) Pub. Date: Jan. 30, 2025

(54) METHOD AND APPARATUS FOR MULTI-HOP UE FOR UE-TO-NETWORK RELAY DISCOVERY IN A WIRELESS COMMUNICATION SYSTEM

(71) Applicant: ASUS Technology Licensing Inc., Taipei City (TW)

(72) Inventor: Richard Lee-Chee Kuo, Taipei City (TW)

(21) Appl. No.: 18/781,798

(22) Filed: Jul. 23, 2024

Related U.S. Application Data
(60) Provisional application No. 63/529,312, filed on Jul. 27, 2023.

(51) Int. Cl. H04W 40/24; H04W 88/04

(52) U.S. Cl. CPC H04W 40/246; H04W 88/04

(57) ABSTRACT

A method and device for UE-to-Network (U2N) Relay discovery are disclosed. In one embodiment, a second relay UE receives a first U2N Relay discovery message from a first relay UE, wherein the first U2N Relay discovery message includes a User Info Identity (ID) of the first relay UE, a Layer-2 ID of a third relay UE, and an ID of a serving cell of the third relay UE. Furthermore, the second relay UE transmits a second U2N Relay discovery message to a remote UE, wherein the second U2N Relay discovery message includes a User Info ID of the second relay UE, the Layer-2 ID, and the ID of the serving cell.

### CROSS-REFERENCE TO RELATED APPLICATIONS

The present Application claims the benefit of U.S. Provisional Patent Application Ser. No. 63/529,312 filed on Jul. 27, 2023, the entire disclosure of which is incorporated herein in its entirety by reference.

### FIELD

This disclosure generally relates to wireless communication networks, and more particularly, to a method and apparatus for multi-hop UE-to-Network Relay discovery in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for UE-to-Network (U2N) Relay discovery are disclosed. In one embodiment, a second relay UE receives a first U2N Relay discovery message from a first relay UE, wherein the first U2N Relay discovery message includes a User Info Identity (ID) of the first relay UE, a Layer-2 ID of a third relay UE, and an ID of a serving cell of the third relay UE. Furthermore, the second relay UE transmits a second U2N Relay discovery message to a remote UE, wherein the second U2N Relay discovery message includes a User Info ID of the second relay UE, the Layer-2 ID, and the ID of the serving cell.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 4.2.7.1-1 of 3GPP TS 23.304 V18.2.0.

FIG. 6 is a reproduction of FIG. 4.2.7.2-1 of 3GPP TS 23.304 V18.2.0.

FIG. 7 is a reproduction of FIG. 6.3.2.1-1 of 3GPP TS 23.304 V18.2.0.

FIG. 8 is a reproduction of FIG. 6.3.2.1-2 of 3GPP TS 23.304 V18.2.0.

FIG. 9 is a reproduction of FIG. 6.3.2.3.2-1 of 3GPP TS 23.304 V18.2.0.

FIG. 10 is a reproduction of FIG. 6.3.2.3.3-1 of 3GPP TS 23.304 V18.2.0.

FIG. 11 is a reproduction of FIG. 6.5.1.1-1 of 3GPP TS 23.304 V18.2.0.

FIG. 12 is a reproduction of FIG. 6.5.1.3-1 of 3GPP TS 23.304 V18.2.0.

FIG. 13 is a reproduction of FIG. 6.5.2.2-1 of 3GPP TS 23.304 V18.2.0.

FIG. 14 is a reproduction of FIG. 16.12.5.1-1 of 3GPP TS 38.300 V17.5.0.

FIG. 15 is a reproduction of FIG. 16.12.6.1-1 of 3GPP TS 38.300 V17.5.0.

FIG. 16 is a reproduction of FIG. 16.12.6.2-1 of 3GPP TS 38.300 V17.5.0.

FIG. 17 illustrates an exemplary 3-hop UE-to-Network Relay according to one exemplary embodiment.

FIG. 18 illustrates a multi-route UE-to-Network Relay according one exemplary embodiment.

FIG. 19 illustrates a multi-hop UE-to-Network Relay Discovery with Model B according to one exemplary embodiment.

FIG. 20 illustrates a remote UE measurement reporting with Model A according to one exemplary embodiment.

FIG. 21 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TS 23.304 V18.2.0, “Proximity based Services (ProSe) in the 5G System (5GS) (Release 18)”; TS 38.300 V17.5.0, “NR; NR and NG-RAN Overall Description; Stage 2 (Release 17)”; and TS 22.261 V19.3.0, “Service requirements for the 5G system; Stage 1 (Release 19)”. The standards and documents listed above are hereby expressly incorporated by reference in their entirety.

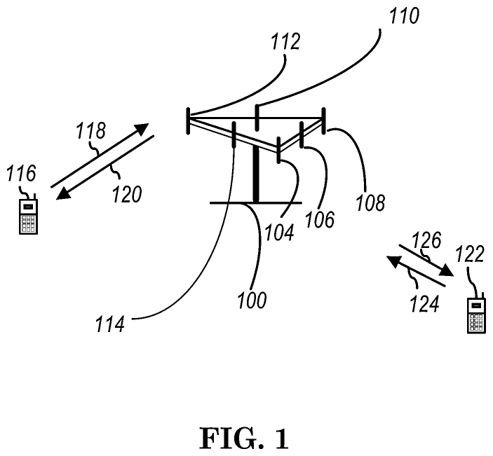

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

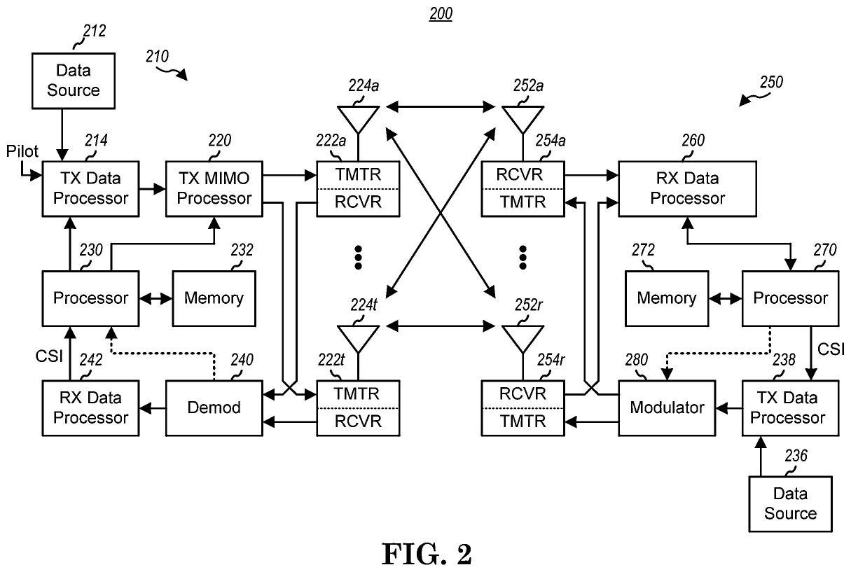

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

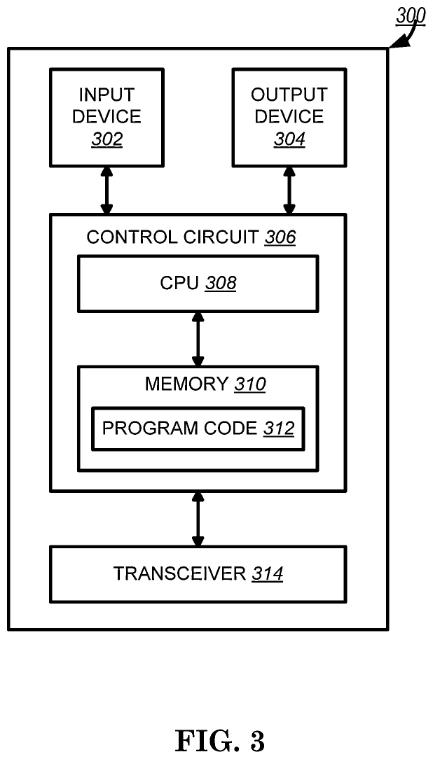

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

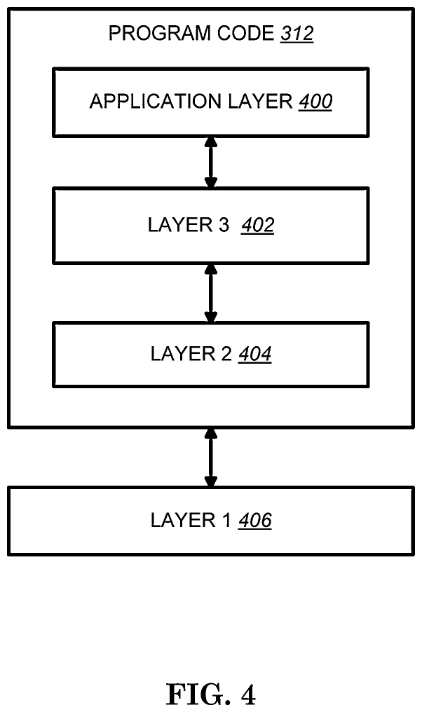

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TS 23.304 specifies procedures related to UE-to-Network Relay as follows:

### 4.2.7 5G ProSe UE-to-Network Relay Reference Architecture

### 4.2.7.1 5G ProSe Layer-3 UE-to-Network Relay Reference Architecture

The following FIG. 4.2.7.1-1 shows the high level reference architecture for 5G ProSe Layer-3 UE-to-Network Relay. In this figure, the 5G ProSe Layer-3 UE-to-Network Relay may be in the HPLMN or a VPLMN.

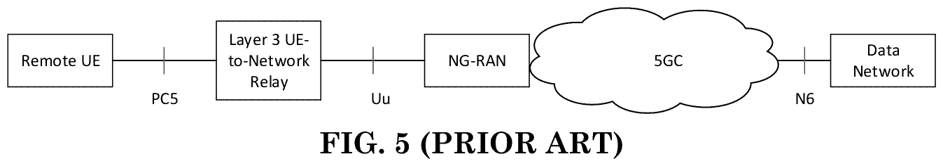

### FIG. 4.2.7.1-1 of 3GPP TS 23.304 V18.2.0, Entitled “Reference Architecture for 5G ProSe Layer-3 UE-to-Network Relay”, is Reproduced as FIG. 5

[ . . . ]

### 4.2.7.2 5G ProSe Layer-2 UE-to-Network Relay Reference Architecture

FIG. 4.2.7.2-1 shows the 5G ProSe Layer-2 UE-to-Network Relay reference architecture. The 5G ProSe Layer-2 Remote UE and 5G ProSe Layer-2 UE-to-Network Relay may be served by the same or different PLMNs. If the serving PLMNs of the 5G ProSe Layer-2 Remote UE and the 5G ProSe Layer-2UE-to-Network Relay are different then NG-RAN is shared by the serving PLMNs, see the 5G MOCN architecture in clause 5.18 of TS 23.501 [4].

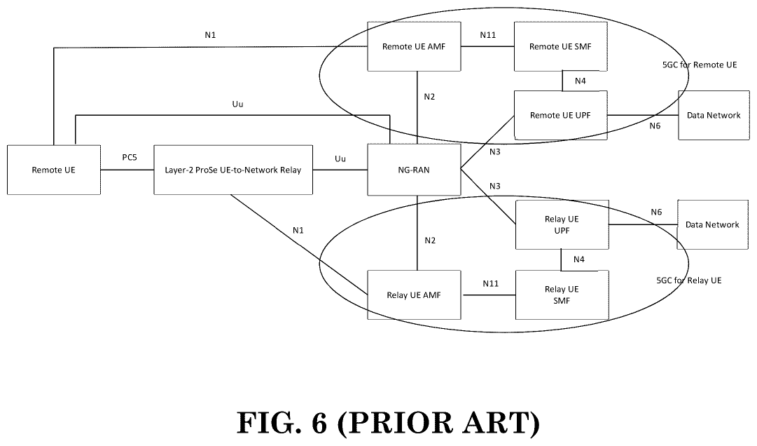

### FIG. 4.2.7.2-1 of 3GPP TS 23.304 V18.2.0, Entitled “5G ProSe Layer-2 UE-to-Network Relay Reference Architecture”, is Reproduced as FIG. 6

NOTE 1: Uu between the 5G ProSe Layer-2 Remote UE and NG-RAN consists of RRC, SDAP and PDCP.
NOTE 2: The 5G ProSe Layer-2 Remote UE and 5G ProSe Layer-2 UE-to-Network Relay are served by the same NG-RAN. The Core Network entities (e.g., AMF, SMF, UPF) serving the 5G ProSe Layer-2 Remote UE and the 5G ProSe Layer-2 UE-to-Network Relay can be the same or different.
   [ . . . ]

### 6.3.2 5G ProSe Direct Discovery Procedures Over PC5 Reference Point

### 6.3.2.1 General

A PC5 communication channel is used to carry the discovery message over PC5 and the discovery message over PC5 is differentiated from other PC5 messages by AS layer. Both Model A and Model B discovery as defined in TS 23.303 [3] are supported:
Model A uses a single discovery protocol message (Announcement).
Model B uses two discovery protocol messages (Solicitation and Response).
   Depicted in FIG. 6.3.2.1-1 is the procedure for 5G ProSe Direct Discovery with Model A.

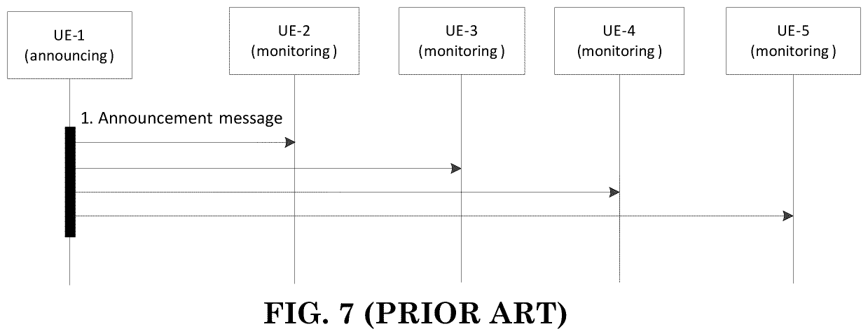

### FIG. 6.3.2.1-1 of 3GPP TS 23.304 V18.2.0, Entitled “5G ProSe Direct Discovery with Model A”, is Reproduced as FIG. 7

1. The Announcing UE sends an Announcement message. The Announcement message may include the Type of Discovery Message, ProSe Application Code or ProSe Restricted Code, relay_Indication, security protection element, [metadata information]. The Application layer metadata information may be included as metadata in the Announcement message. The Destination Layer-2 ID and Source Layer-2 ID used to send the Announcement message are specified in clause 5.8.1.2 and clause 5.8.1.3.
   Announcing UE includes the relay_Indication if 5G ProSe UE-to-UE Relay(s) can broadcast its User Info ID during the 5G ProSe UE-to-UE Discovery.
   The Monitoring UE determines the Destination Layer-2 ID for signalling reception. The Destination Layer-2 ID is configured with the UE(s) as specified in clause 5.8.1.2.
      Depicted in FIG. 6.3.2.1-2 is the procedure for 5G ProSe Direct Discovery with Model B.

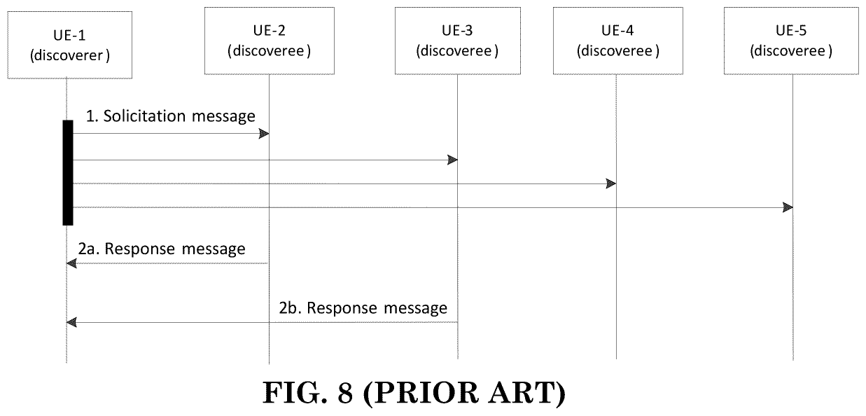

### FIG. 6.3.2.1-2 of 3GPP TS 23.304 V18.2.0, Entitled “5G ProSe Direct Discovery with Model B”, is Reproduced as FIG. 8

1. The Discoverer UE sends a Solicitation message. The Solicitation message may include Type of Discovery Message, ProSe Query Code, relay_Indication, security protection element.
   The Destination Layer-2 ID and Source Layer-2 ID used to send the Solicitation message are specified in clause 5.8.1.2 and clause 5.8.1.3.
   How the Discoveree UE determines the Destination Layer-2 ID for signalling reception is specified in clause 5.8.1.2.
   Discoverer UE includes the relay_Indication if 5G ProSe UE-to-UE Relay(s) can broadcast its User Info ID during the 5G ProSe UE-to-UE Discovery.
2. The Discoveree UE that matches the solicitation message responds to the Discoverer UE with the Response message. The Response message may include Type of Discovery Message, ProSe Response Code, relay_Indication, security protection element, [metadata information]. The Application layer metadata information may be included as metadata in the Response message.
   Discoveree UE includes relay_Indication if 5G ProSe UE-to-UE Relay(s) can broadcast its User Info ID during the 5G ProSe UE-to-UE Discovery.
   The Source Layer-2 ID used to send the Response message is specified in clause 5.8.1.3.
   The Destination Layer-2 ID is set to the Source Layer-2 ID of the received Solicitation message.
NOTE: Details of security protection element are specified in TS 33.503 [29].
   [ . . . ]

### 6.3.2.3 5G ProSe UE-to-Network Relay Discovery

### 6.3.2.3.1 General

5G ProSe UE-to-Network Relay Discovery is applicable to both 5G ProSe Layer-3 and Layer-2 UE-to-Network relay discovery for public safety use and commercial services. To perform 5G ProSe UE-to-Network Relay Discovery, the 5G ProSe Remote UE and the 5G ProSe UE-to-Network Relay are pre-configured or provisioned with the related information as described in clause 5.1.
In 5G ProSe UE-to-Network Relay Discovery, the UEs use pre-configured or provisioned information for the relay discovery procedures as defined in clause 5.1.4.1.
The Relay Service Code (RSC) is used in the 5G ProSe UE-to-Network Relay discovery, to indicate the connectivity service the 5G ProSe UE-to-Network Relay provides to the 5G ProSe Remote UE. The RSCs (including the dedicated one(s) for emergency service) are configured on the 5G ProSe UE-to-Network Relay and the 5G ProSe Remote UE as defined in clause 5.1.4. The 5G ProSe UE-to-Network Relay and the 5G ProSe Remote UE are aware of whether a RSC is offering 5G ProSe Layer-2 or Layer-3 UE-to-Network Relay service and whether a RSC is for emergency service, based the policy as specified in clause 5.1.4. A 5G ProSe UE-to-Network Relay supporting multiple RSCs can advertise the RSCs using multiple discovery messages, with one RSC per discovery message.
NOTE: When the 5G ProSe UE-to-Network Relay can advertise the emergency RSC(s) is specified in clause 5.4.4.
   Additional information not directly used for discovery can also be advertised using the PC5-D protocol stack in single or separate discovery messages of type “Relay Discovery Additional Information” as defined in clause 5.8.3.1.
   6.3.2.3.2 Procedure for 5G ProSe UE-to-Network Relay Discovery with Model A
   Depicted in FIG. 6.3.2.3.2-1 is the Procedure for 5G ProSe UE-to-Network Discovery with Model A.

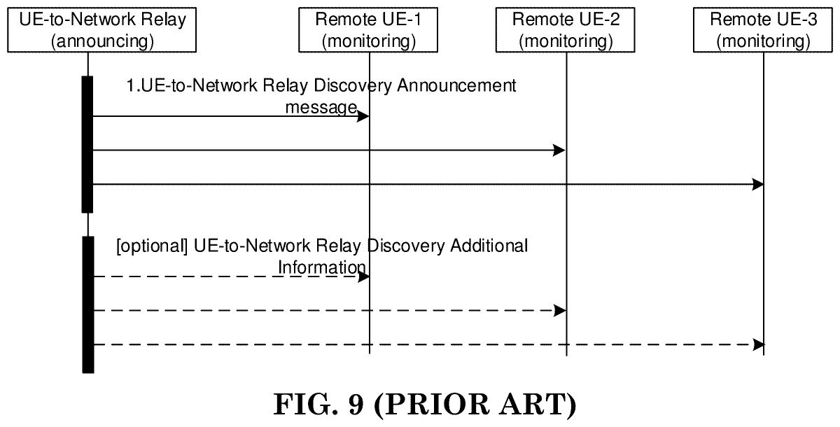

### FIG. 6.3.2.3.2-1 of 3GPP TS 23.304 V18.2.0, Entitled “5G ProSe UE-to-Network Relay Discovery with Model A”, is Reproduced as FIG. 9

1. The 5G ProSe UE-to-Network Relay sends a UE-to-Network Relay Discovery Announcement message. The UE-to-Network Relay Discovery Announcement message contains the Type of Discovery Message, Announcer Info and RSC, and is sent using the Source Layer-2 ID and Destination Layer-2 ID as described in clause 5.8.3.
   For 5G ProSe Layer-3 UE-to-Network Relay, the 5G ProSe Layer-3 UE-to-Network Relay shall only include a RSC in the UE-to-Network Relay Discovery Announcement when the S-NSSAI associated with that RSC belongs to the Allowed NSSAI of the UE-to-Network Relay.
   The 5G ProSe Remote UE (1 to 3) determines the Destination Layer-2 ID for signalling reception. The Destination Layer-2 ID is configured with the UE(s) as specified in clause 5.1.4.1.
   5G ProSe Remote UE (1 to 3) monitors announcement messages with the 5G ProSe UE-to-Network RSC corresponding to the desired services.
      Optionally, the 5G ProSe UE-to-Network Relay may also send Relay Discovery Additional Information messages as defined in clause 6.5.1.3. The parameters contained in this message and the Source Layer-2 ID and Destination Layer-2 ID used for sending and receiving the message are described in clause 5.8.3.
      The 5G ProSe Remote UE selects the 5G ProSe UE-to-Network Relay based on the information received in step 1.
NOTE: Access Stratum layer information used for 5G ProSe UE-to-Network Relay selection is specified in RAN specifications.
   6.3.2.3.3 Procedure for 5G ProSe UE-to-Network Relay Discovery with Model B
   Depicted in FIG. 6.3.2.3.3-1 is the procedure for 5G ProSe UE-to-Network Relay Discovery with Model B.

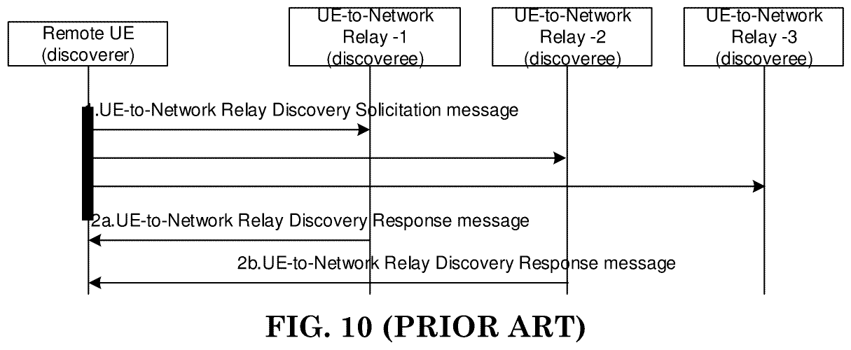

### FIG. 6.3.2.3.3-1 of 3GPP TS 23.304 V18.2.0, Entitled “5G ProSe UE-to-Network Relay Discovery with Model B”, is Reproduced as FIG. 10

1. The 5G ProSe Remote UE sends a 5G ProSe UE-to-Network Relay Discovery Solicitation message. The 5G ProSe UE-to-Network Discovery Solicitation message contains the Type of Discovery Message, Discoverer Info, RSC and optionally Target Info, and is send using the Source Layer-2 ID and Destination Layer-2 ID as described in clause 5.8.3. The 5G ProSe Remote UE discovering a 5G ProSe UE-to-Network Relay sends a solicitation message with the RSC which is associated to the desired connectivity service. The RSC is based on the Policy/Parameters specified in clause 5.1.4.1.
   How the 5G ProSe UE-to-Network Relays (1 to 3) determine the Destination Layer-2 ID for signalling reception is specified in clause 5.8.3. The Destination Layer-2 ID is configured with the UE(s) as specified in clause 5.1.4.1.
2. The 5G ProSe UE-to-Network Relays (1 and 2) that match the values of the RSC contained and the Target Info, if any, in the solicitation message respond to the 5G ProSe Remote UE with a UE-to-Network Relay Discovery Response message. The 5G ProSe UE-to-Network Relay Discovery Response message contains the Type of Discovery Message, Discoveree Info and RSC, and is sent using the Source Layer-2 ID and Destination Layer-2 ID as described in clause 5.8.3.
   For 5G ProSe Layer-3 UE-to-Network Relay, the 5G ProSe UE-to-Network Relay shall only respond to a matching RSC in the UE-to-Network Relay Discovery Solicitation message when the S-NSSAI associated with that RSC belongs to the Allowed NSSAI of the 5G ProSe UE-to-Network Relay.
      The 5G ProSe Remote UE selects the 5G ProSe UE-to-Network Relay based on the information received in step 2.
      [ . . . ]

### 6.5.1 5G ProSe Communication Via 5G ProSe Layer-3 UE-to-Network Relay

### 6.5.1.0 General

5G ProSe Communication via 5G ProSe Layer-3 UE-to-Network Relay may be performed with or without involving N3IWF for non-emergency service and for emergency service as specified in clause 5.4.4.
6.5.1.1 5G ProSe Communication Via 5G ProSe Layer-3 UE-to-Network Relay without N3IWF
A 5G ProSe Layer-3 UE-to-Network Relay registers to the network (if not already registered). 5G ProSe Layer-3 UE-to-Network Relay establishes a PDU Session(s) or modifies an existing PDU Session(s) in order to provide relay traffic towards 5G ProSe Layer-3 Remote UE(s). PDU Session(s) supporting 5G ProSe Layer-3 UE-to-Network Relay shall only be used for 5G ProSe Layer-3 Remote UE(s) relay traffic.
The PLMN serving the 5G ProSe Layer-3 UE-to-Network Relay and the PLMN to which the 5G ProSe Layer-3 Remote UE registers can be the same PLMN or two different PLMNs.

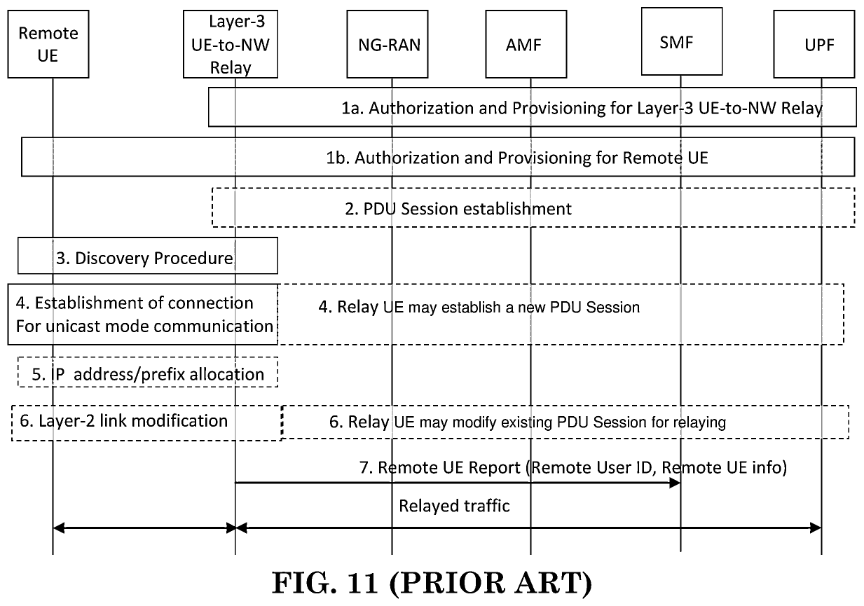

### FIG. 6.5.1.1-1 of 3GPP TS 23.304 V18.2.0, Entitled “5G ProSe Communication Via 5G ProSe Layer-3 UE-to-Network Relay without N3IWF”, is Reproduced as FIG. 11

1. Service authorization and provisioning are performed for the 5G ProSe Layer-3 UE-to-Network Relay (step 1a) and 5G ProSe Layer-3 Remote UE (step 1b) as described in clause 6.2.
2. The 5G ProSe Layer-3 UE-to-Network Relay may establish a PDU Session for relaying. In the case of IPv6, the 5G ProSe Layer-3 UE-to-Network Relay obtains the IPv6 prefix via prefix delegation function from the network as defined in TS 23.501 [4].
NOTE 1: 5G ProSe Layer-3 UE-to-Network Relay can establish a PDU Session for any Relay Service Code it supports before the connection is established with the 5G ProSe Layer-3 Remote UE.
3. The 5G ProSe Layer-3 Remote UE performs discovery of a 5G ProSe Layer-3 UE-to-Network Relay as described in clause 6.3.2.3. As part of the discovery procedure the 5G ProSe Layer-3 Remote UE learns about the connectivity service the 5G ProSe Layer-3 UE-to-Network Relay provides.
4. The 5G ProSe Layer-3 Remote UE selects a 5G ProSe Layer-3 UE-to-Network Relay and establishes a connection for unicast mode communication as described in clause 6.4.3.6. If there is no PDU Session associated with the Relay Service Code or a new PDU Session for relaying is needed, the 5G ProSe Layer-3 UE-to-Network Relay initiates a new PDU Session establishment procedure for relaying before completing the PC5 connection establishment.
   When the 5G ProSe Layer-3 Remote UE sends the Direct Communication Request message including the dedicated emergency RSC, the 5G ProSe Layer-3 UE-to-Network Relay sets up an emergency PDU session for relaying the emergency service if there is not an emergency PDU Session established in step 2.
NOTE 2: If the 5G ProSe Layer-3 UE-to-Network Relay has its own emergency service ongoing, how to handle the conflict case is specified in clause 5.4.4.3.
   The network decides that the PDU Session to be established is for relay traffic, and then generates the QoS rules and QoS Flow level QoS parameters to 5G ProSe Layer-3 UE-to-Network Relay with relay consideration and can initiate the setup of QoS flows as specified in clause 5.6.2.1. The Remote UE can also initiate the setup of QoS flows by providing PC5 QoS info and (optionally) PC5 QoS rule(s) to the 5G ProSe Layer-3 UE-to-Network Relay during connection setup, according to the procedure as specified in clause 5.6.2.1.
   The 5G ProSe Layer-3 UE-to-Network Relay determines the PDU Session type for relaying as specified in clause 5.4.1.1.
   According to the PDU Session Type for relaying, the 5G ProSe Layer-3 UE-to-Network Relay performs relaying function at the corresponding layer as follows:
      When the IP type PDU Session is used for IP traffic over PC5 reference point, the 5G ProSe Layer-3 UE-to-Network Relay acts as an IP router. For IPv4, the 5G ProSe Layer-3 UE-to-Network Relay performs IPv4 NAT between IPv4 addresses assigned to the 5G ProSe Layer-3 Remote UE and the IPv4 address assigned to the PDU Session used for the relay traffic.
      When the Ethernet type PDU Session is used for Ethernet traffic over PC5 reference point, the 5G ProSe Layer-3 UE-to-Network Relay acts as an Ethernet switch.
      When the Unstructured type PDU Session is used for Unstructured traffic over PC5 reference point, the 5G ProSe Layer-3 UE-to-Network Relay performs traffic relaying based on a mapping between the PC5 Link Identifier and the PDU Session ID, and a mapping between PFI for PC5 Layer-2 link and the QFI for the PDU Session. These mappings are created when the Unstructured type PDU Session is established for the 5G ProSe Layer-3 Remote UE.
      When the IP type PDU Session is used for Ethernet or Unstructured traffic over PC5 reference point, the 5G ProSe Layer-3 UE-to-Network Relay uses IP tunneling. For this IP tunnelling, the 5G ProSe Layer-3 UE-to-Network Relay locally assigns an IP address/prefix for the 5G ProSe Layer-3 Remote UE and uses it on the Uu reference point to encapsulate and decapsulate the uplink and downlink traffic for the 5G ProSe Layer-3 Remote UE. The tunnelled traffic over Uu reference point is transported over the PC5 reference point as Ethernet or Unstructured traffic.
5. For IP PDU Session Type and IP traffic over PC5 reference point, IPv6 prefix or IPv4 address (including NAT case) is allocated for the 5G ProSe Layer-3 Remote UE as defined in clause 5.5.1.3.
6. The 5G ProSe Layer-3 Remote UE may provide PC5 QoS Info and PC5 QoS rule(s) to the 5G ProSe Layer-3 UE-to-Network Relay using Layer-2 link modification procedure as specified in clause 6.4.3.4. The 5G ProSe Layer-3 UE-to-Network Relay generates the Packet Filters used over Uu interface based on the received PC5 QoS Info and QoS Rule(s) as described in clause 5.6.2.1, and may perform the UE requested PDU Session Modification as defined in TS 23.502 [5] clause 4.3.3 to setup a new QoS Flow or bind the traffic to an existing QoS Flow.
   From this point the uplink and downlink relaying can start. For downlink traffic forwarding, the PC5 QoS Rule is used to map the downlink packet to the PC5 QoS Flow. For uplink traffic forwarding, the 5G QoS Rule is used to map the uplink packet to the Uu QoS Flow.
7. The 5G ProSe Layer-3 UE-to-Network Relay shall send a Remote UE Report (Remote User ID, Remote UE info) message to the SMF for the PDU Session associated with the relay. The Remote User ID, as defined in TS 33.503 [29], is an identity of the 5G ProSe Layer-3 Remote UE user that was successfully connected in step 4. The Remote UE info is used to assist identifying the 5G ProSe Layer-3 Remote UE in the 5GC. For IP PDU Session Type, the Remote UE info is Remote UE IP info. For Ethernet PDU Session Type, the Remote UE info is Remote UE MAC address which is detected by the 5G ProSe Layer-3 UE-to-Network Relay. For Unstructured PDU Session Type, the Remote UE info is not included. The SMF stores the Remote User IDs and the related Remote UE info in the 5G ProSe Layer-3 UE-to-Network Relay's SM context for this PDU Session associated with the relay.
   The Remote UE Report is N1 SM NAS message sent with the PDU Session ID to the AMF, in turn delivered to the SMF.
NOTE 3: The privacy protection for Remote User ID is specified in TS 33.503 [29].
   For IP info the following principles apply:
      for IPv4, the 5G ProSe Layer-3 UE-to-Network Relay shall report TCP/UDP port ranges assigned to individual 5G ProSe Layer-3 Remote UE(s) (along with the Remote User ID);
      for IPv6, the 5G ProSe Layer-3 UE-to-Network Relay shall report IPv6 prefix(es) assigned to individual 5G ProSe Layer-3 Remote UE(s) (along with the Remote User ID).
         If the PDU Session for relaying is released by the UE-to-Network Relay or the network as described in clause 4.3.4 of TS 23.502 [5], the UE-to-Network Relay should initiate the release of the layer-2 links associated with the released PDU Session using the procedure defined in clause 6.4.3.3.
         The PDU Session(s) used for relaying should be released as described in clause 4.3.4 of TS 23.502 [5] (e.g. by 5G ProSe Layer-3 UE-to-Network Relay), if the service authorization for acting as a 5G ProSe Layer-3 UE-to-Network Relay in the serving PLMN is revoked.
         The 5G ProSe Layer-3 UE-to-Network Relay shall send the Remote UE Report message when the 5G ProSe Layer-3 Remote UE disconnects from the 5G ProSe Layer-3 UE-to-Network Relay (e.g. upon explicit layer-2 link release or based on the absence of keep alive messages over PC5) to inform the SMF that the 5G ProSe Layer-3 Remote UE(s) have left.
NOTE 4: In order for the SMF to have the 5G ProSe Layer-3 Remote UE(s) information, the HPLMN and the VPLMN where the 5G ProSe Layer-3 UE-to-Network Relay is authorised to operate, needs to support the transfer of the 5G ProSe Layer-3 Remote UE related parameters if the SMF is in the HPLMN.
   It is up to 5G ProSe Layer-3 UE-to-Network Relay implementation how PDU Session(s) used for relaying are released or QoS Flow(s) used for relaying are removed by the 5G ProSe Layer-3 UE-to-Network Relay when 5G ProSe Layer-3 Remote UE(s) disconnect from the 5G ProSe Layer-3 UE-to-Network Relay.
   [ . . . ]

### 6.5.1.3 Additional Parameters Announcement Procedure

Additional parameters announcement procedure outlined in FIG. 6.5.1.3-1 is used by a 5G ProSe Remote UE to request a 5G ProSe UE-to-Network Relay to announce additional parameters (for model A) as defined in clause 5.8.3.

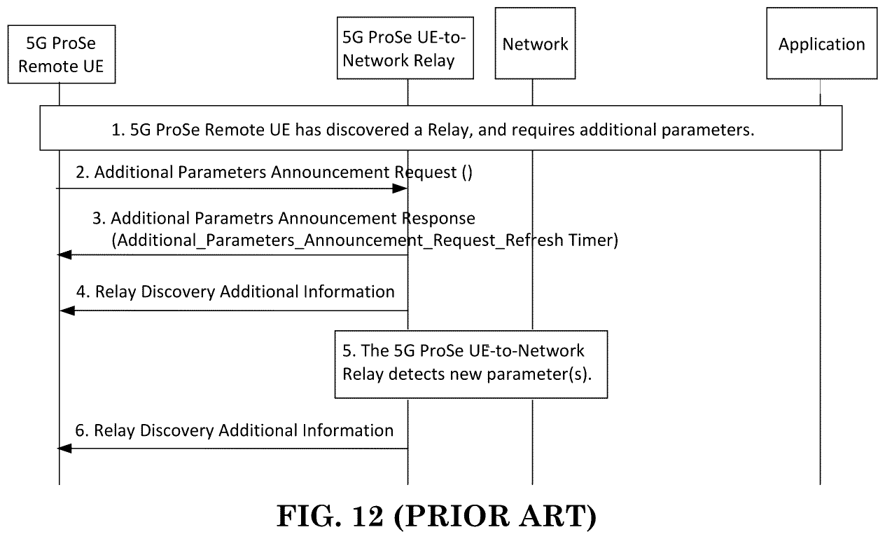

### FIG. 6.5.1.3-1 of 3GPP TS 23.304 V18.2.0, Entitled “Additional Parameters Announcement Procedure”, is Reproduced as FIG. 12

1. 5G ProSe Remote UE has discovered a 5G ProSe UE-to-Network Relay and requires additional parameters.
2. The 5G ProSe Remote UE sends to the 5G ProSe UE-to-Network Relay an Additional Parameters Announcement Request to obtain additional parameters.
3. The 5G ProSe UE-to-Network Relay acknowledges receipt of the request in step 2 with an Additional Parameters Announcement Response (Additional_Parameters_Announcement_Request_Refresh Timer). The Additional_Parameters_Announcement_Request_Refresh Timer (configurable in the 5G ProSe UE-to-Network Relay), is provided to the 5G ProSe Remote UE so that when this timer expires the 5G ProSe Remote UE repeats the Additional Parameters Announcement Request procedure if it still needs to obtain the additional parameters. If the 5G ProSe Remote UE does not initiate new Additional Parameters Announcement Request procedure when this Additional_Parameters_Announcement_Request_Refresh Timer expires and no other UE request additional parameters announcement before the Additional_Parameters_Announcement_Request_Refresh timer expires in the 5G ProSe UE-to-Network Relay, then the relay shall stop announcing the additional parameters.
4. The 5G ProSe UE-to-Network Relay announces the additional parameters by sending Relay Discovery Additional Information message as defined in clause 5.8.3. This is repeated periodically with a configurable frequency (normally higher than the one related to the Additional_Parameters_Announcement_Request_Refresh Timer) until there is no UE requesting to announce the additional parameters as determined by the Additional_Parameters_Announcement_Request_Refresh Timer running in the 5G ProSe UE-to-Network Relay.
NOTE: Based on UE implementation, the 5G ProSe UE-to-Network Relay can send the Relay Discovery Additional Information message several times consecutively in step 4 if there are other 5G ProSe Remote UE(s) that have connected to the 5G ProSe UE-to-Network Relay but not yet requested any additional parameters. This ensures the other 5G ProSe Remote UE(s) obtain such additional parameters without invoking any new request(s).
5. The 5G ProSe UE-to-Network Relay detects new or updated additional parameters.
6. Detection of new or updated additional parameters in step 5 triggers the 5G ProSe UE-to-Network Relay to announce the additional parameters by sending a Relay Discovery Additional Information Message immediately and to repeat it periodically with a configurable frequency as in step 4 until there are no UEs requesting to announce the additional parameters, i.e. until the Additional_Parameters_Announcement_Request_Refresh Timer expires in the 5G ProSe UE-to-Network Relay.

### 6.5.2 5G ProSe Communication Via 5G ProSe Layer-2 UE-to-Network Relay

[ . . . ]

### 6.5.2.2 Connection Establishment

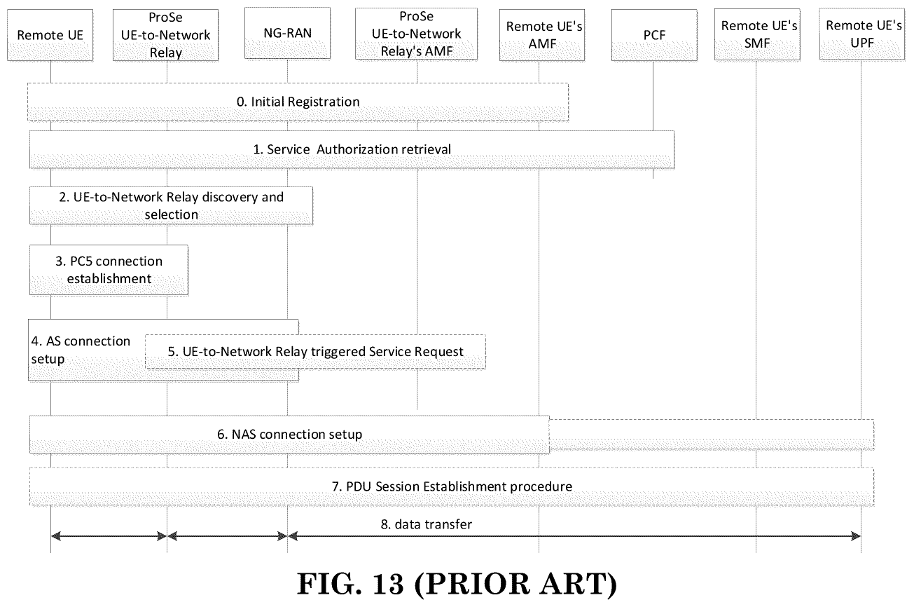

### FIG. 6.5.2.2-1 of 3GPP TS 23.304 V18.2.0, Entitled “Connection Establishment for 5G ProSe Layer-2 UE-to-Network Relay”, is Reproduced as FIG. 13

0. If in coverage, the 5G ProSe Layer-2 Remote UE and 5G ProSe Layer-2 UE-to-Network Relay may independently perform the initial registration to the network according to registration procedures in TS 23.502 [5].
1. If in coverage, the 5G ProSe Layer-2 Remote UE and 5G ProSe Layer-2 UE-to-Network Relay independently get the service authorization for 5G ProSe Layer-2 UE-to-Network Relay operation from the network. Service authorization and parameters provisioning for 5G ProSe Layer-2 UE-to-Network Relay operation are performed for the 5G ProSe Layer-2 UE-to-Network Relay and 5G ProSe Layer-2 Remote UE as specified in clause 5.1.4. If the 5G ProSe Layer-2 Remote UE is “not served by NG-RAN”, the pre-configured parameters are used, and the service authorization and parameters may be updated after step 6.
   If the 5G ProSe Layer-2 Remote UE has not performed Initial Registration, the 5G ProSe Layer-2 Remote UE may perform the Initial Registration in step 6.
2. The 5G ProSe Layer-2 Remote UE and 5G ProSe Layer-2 UE-to-Network Relay perform 5G ProSe UE-to-Network Relay Discovery and selection, as specified in clause 6.3.2.3.
3. The 5G ProSe Layer-2 Remote UE initiates a one-to-one communication connection with the selected 5G ProSe Layer-2 UE-to-Network Relay over PC5 using the procedure as described in clause 6.4.3.
4. The 5G ProSe Layer-2 Remote UE establishes an RRC Connection with the same NG-RAN serving the selected 5G ProSe Layer-2 UE-to-Network Relay, specified in TS 38.300 [12]. The 5G ProSe Layer-2 Remote UE sets the RRC Establishment Cause as defined in TS 38.331 [16].
5. During step 4, if the 5G ProSe Layer-2 UE-to-Network Relay is in CM_IDLE state and receives a trigger from the AS layer to enter CM-CONNECTED state due to Remote UE's AS layer connection set up with the NG-RAN, the 5G ProSe Layer-2 UE-to-Network Relay performs Service Request procedure in the clause 4.2.3.2 of TS 23.502 [5].
6. The 5G ProSe Layer-2 Remote UE sends a NAS message to the serving AMF. The NAS message is encapsulated in an Uu RRC message that is sent over PC5 to the 5G ProSe Layer-2 UE-to-Network Relay, and the 5G ProSe Layer-2 UE-to-Network Relay forwards the Uu RRC message to the NG-RAN specified in TS 38.300 [12]. NG-RAN selects the 5G ProSe Layer-2 Remote UE's serving AMF and forwards the NAS message to this AMF. If 5G ProSe Layer-2 Remote UE has not performed the initial registration, the NAS message is an initial Registration message. Otherwise, the NAS message is either a service request message, or a mobility or periodic Registration message taking into account the TAI in the RRC container received from the 5G ProSe Layer-2 UE-to-Network Relay during Relay Discovery (see clause 5.8.3.3) or PC5-RRC message, as specified in TS 38.300 [12].
7. The 5G ProSe Layer-2 Remote UE may trigger the PDU Session Establishment procedure as defined in clause 4.3.2.2 of TS 23.502 [5].
8. The data is transferred between the 5G ProSe Layer-2 Remote UE and UPF via the 5G ProSe Layer-2 UE-to-Network Relay and NG-RAN. The 5G ProSe Layer-2 UE-to-Network Relay forwards all the data messages between the 5G ProSe Layer-2 Remote UE and NG-RAN, as specified in TS 38.300 [12].

3GPP TS 38.300 specifies procedures related to UE-to-Network Relay as follows:

### 16.12 Sidelink Relay

### 16.12.1 General

Sidelink relay is introduced to support 5G ProSe UE-to-Network Relay (U2N Relay) function (specified in TS 23.304 [48]) to provide connectivity to the network for U2N Remote UE(s). Both L2 and L3 U2N Relay architectures are supported. The L3 U2N Relay architecture is transparent to the serving NG-RAN of the U2N Relay UE, except for controlling sidelink resources. The detailed architecture and procedures for L3 U2N Relay can be found in TS 23.304 [48].
A U2N Relay UE shall be in RRC_CONNECTED to perform relaying of unicast data.
For L2 U2N Relay operation, the following RRC state combinations are supported:
Both L2 U2N Relay UE and L2 U2N Remote UE shall be in RRC_CONNECTED to perform transmission/reception of relayed unicast data; and
The L2 U2N Relay UE can be in RRC_IDLE, RRC_INACTIVE or RRC_CONNECTED as long as all the L2 U2N Remote UE(s) that are connected to the L2 U2N Relay UE are either in RRC_INACTIVE or in RRC_IDLE.
   A single unicast link is established between one L2 U2N Relay UE and one L2 U2N Remote UE. The traffic to the NG-RAN of L2 U2N Remote UE via a given L2 U2N Relay UE and the traffic of the L2 U2N Relay UE shall be separated in different Uu RLC channels.
   For L2 U2N Relay, the L2 U2N Remote UE can only be configured to use resource allocation mode 2 (as specified in 5.7.2 and 16.9.3.1) for data to be relayed.
   [ . . . ]

### 16.12.3 Relay Discovery

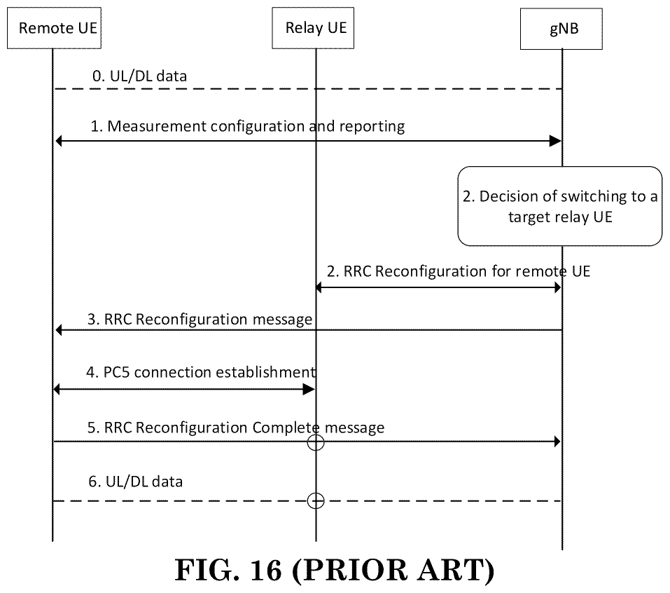

Model A and Model B discovery models as defined in TS 23.304 are supported for U2N Relay discovery. The protocol stack used for discovery is illustrated in FIG. 16.12.3-1.
[ . . . ]
The U2N Remote UE can perform Relay discovery message (i.e., as specified in TS 23.304 [48]) transmission and may monitor the sidelink for Relay discovery message while in RRC_IDLE, RRC_INACTIVE or RRC_CONNECTED. The network may broadcast or configure via dedicated RRC signalling a Uu RSRP threshold, which is used by the U2N Remote UE to determine if it can transmit Relay discovery messages to U2N Relay UE(s).
The U2N Relay UE can perform Relay discovery message (i.e., as specified in TS 23.304 [48]) transmission and may monitor the sidelink for Relay discovery message while in RRC_IDLE, RRC_INACTIVE or RRC_CONNECTED. The network may broadcast or configure via dedicated RRC signalling a maximum Uu RSRP threshold, a minimum Uu RSRP threshold, or both, which are used by the U2N Relay UE to determine if it can transmit Relay discovery messages to U2N Remote UE(s).
The network may provide the Relay discovery configuration using broadcast or dedicated signalling. In addition, the U2N Remote UE and L3 U2N Relay UE may use pre-configuration for Relay discovery.
The resource pool(s) used for NR sidelink communication can be used for Relay discovery or the network may configure resource pool(s) dedicated for Relay discovery. Resource pool(s) dedicated for Relay discovery can be configured simultaneously with resource pool(s) for NR sidelink communication in system information, dedicated signalling and/or pre-configuration. Whether dedicated resource pool(s) for Relay discovery are configured is based on network implementation. If resource pool(s) dedicated for Relay discovery are configured, only those resource pool(s) dedicated for Relay discovery shall be used for Relay discovery. If only resource pool(s) for NR sidelink communication are configured, all the configured resource pool(s) can be used for Relay discovery and NR sidelink communication.
For U2N Remote UE (including both in-coverage and out of coverage cases) that has been connected to the network via a U2N Relay UE, only resource allocation mode 2 is used for Relay discovery message transmission.
For in-coverage U2N Relay UE, and for both in-coverage and out of coverage U2N Remote UEs, NR sidelink resource allocation principles are applied for Relay discovery message transmission.
The sidelink power control for the transmission of Relay discovery messages is same as for NR sidelink communication.
No ciphering or integrity protection in PDCP layer is applied for the Relay discovery messages.
The U2N Remote UE and U2N Relay UE can determine from SIB12 whether the gNB supports Relay discovery, or Non-Relay discovery, or both.

### 16.12.4 Relay Selection/Reselection

The U2N Remote UE performs radio measurements at PC5 interface and uses them for U2N Relay selection and reselection along with higher layer criteria, as specified in TS 23.304 [48]. When there is no unicast PC5 connection between the U2N Relay UE and the U2N Remote UE, the U2N Remote UE uses SD-RSRP measurements to evaluate whether PC5 link quality towards a U2N Relay UE satisfies relay selection criterion.
For relay reselection, U2N Remote UE uses SL-RSRP measurements towards the serving U2N Relay UE for relay reselection trigger evaluation when there is data transmission from U2N Relay UE to U2N Remote UE, and it is left to UE implementation whether to use SL-RSRP or SD-RSRP for relay reselection trigger evaluation in case of no data transmission from U2N Relay UE to U2N Remote UE.
A U2N Relay UE is considered suitable by a U2N Remote UE in terms of radio criteria if the PC5 link quality measured by U2N Remote UE towards the U2N Relay UE exceeds configured threshold (pre-configured or provided by gNB). The U2N Remote UE searches for suitable U2N Relay UE candidates that meet all AS layer and higher layer criteria (see TS 23.304 [48]). If there are multiple such suitable U2N Relay UEs, it is up to U2N Remote UE implementation to choose one U2N Relay UE among them. For L2 U2N Relay (re) selection, the PLMN ID and cell ID can be used as additional AS criteria.
The U2N Remote UE triggers U2N Relay selection in following cases:
Direct Uu signal strength of current serving cell of the U2N Remote UE is below a configured signal strength threshold;
Indicated by upper layer of the U2N Remote UE.
   The U2N Remote UE may trigger U2N Relay reselection in following cases:
PC5 signal strength of current U2N Relay UE is below a (pre) configured signal strength threshold;
Cell reselection, handover, Uu RLF, or Uu RRC connection establishment/resume failure has been indicated by U2N Relay UE via PC5-RRC signalling;
When U2N Remote UE receives a PC5-S link release message from U2N Relay UE;
When U2N Remote UE detects PC5 RLF;
Indicated by upper layer.
   For L2 U2N Remote UEs in RRC_IDLE or RRC_INACTIVE and L3 U2N Remote UEs, the cell (re) selection procedure and relay (re) selection procedure run independently. If both suitable cells and suitable U2N Relay UEs are available, it is up to the U2N Remote UE implementation to select either a cell or a U2N Relay UE. A L3 U2N Remote UE may select a cell and a L3 U2N Relay UE simultaneously and this is up to implementation of L3 U2N Remote UE.
   For both L2 and L3 U2N Relay UEs in RRC_IDLE or RRC_INACTIVE, the PC5-RRC message(s) are used to inform their connected U2N Remote UE(s) when U2N Relay UEs select a new cell. The PC5-RRC message(s) are also used to inform their connected L2 or L3 U2N Remote UE(s) when L2 or L3 U2N Relay UE performs handover, detects Uu RLF, or its Uu RRC connection establishment/resume fails. Upon reception of the PC5 RRC message for notification, it is up to U2N Remote UE implementation whether to release or keep the unicast PC5 link. If U2N Remote UE decides to release the unicast PC5 link, it triggers the PC5 release procedure and may perform cell or relay reselection.

### 16.12.5 Control Plane Procedures for L2 U2N Relay

### 16.12.5.1 RRC Connection Management

The L2 U2N Remote UE needs to establish its own PDU sessions/DRBs with the network before user plane data transmission.
The NR sidelink PC5 unicast link establishment procedures can be used to setup a secure unicast link between L2 U2N Remote UE and L2 U2N Relay UE before L2 U2N Remote UE establishes a Uu RRC connection with the network via L2 U2N Relay UE.
The establishment of Uu SRB1/SRB2 and DRB of the L2 U2N Remote UE is subject to Uu configuration procedures for L2 UE-to-Network Relay.
The following high level connection establishment procedure in FIG. 16.12.5.1-1 applies to a L2 U2N Relay and L2 U2N Remote UE:

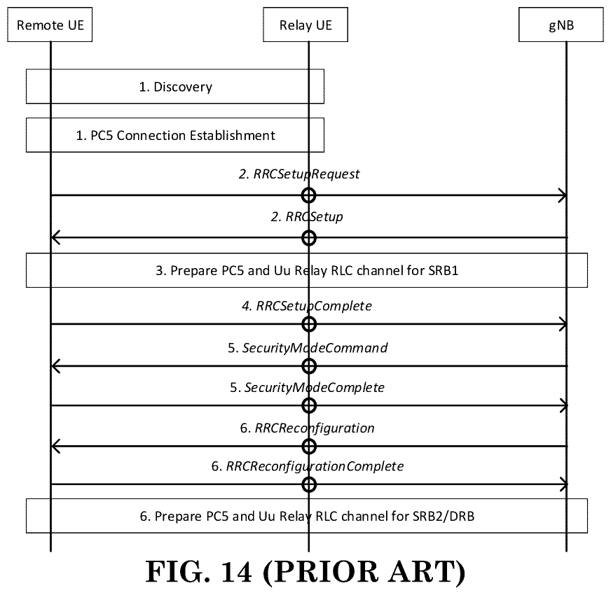

### FIG. 16.12.5.1-1 of 3GPP TS 38.300 V17.5.0, Entitled “Procedure for L2 U2N Remote UE Connection Establishment”, is Reproduced as FIG. 14

1. The L2 U2N Remote and L2 U2N Relay UE perform discovery procedure, and establish a PC5-RRC connection using the NR sidelink PC5 unicast link establishment procedure.
2. The L2 U2N Remote UE sends the first RRC message (i.e., RRCSetupRequest) for its connection establishment with gNB via the L2 U2N Relay UE, using a specified PC5 Relay RLC channel configuration. If the L2 U2N Relay UE is not in RRC_CONNECTED, it needs to do its own Uu RRC connection establishment upon reception of a message on the specified PC5 Relay RLC channel. After L2 U2N Relay UE's RRC connection establishment procedure, gNB configures SRB0 relaying Uu Relay RLC channel to the U2N Relay UE. The gNB responds with an RRCSetup message to L2 U2N Remote UE. The RRCSetup message is sent to the L2 U2N Remote UE using SRB0 relaying Uu Relay RLC channel over Uu and a specified PC5 Relay RLC channel over PC5.
NOTE 1: Void.
3. The gNB and L2 U2N Relay UE perform relaying channel setup procedure over Uu. According to the configuration from gNB, the L2 U2N Relay/Remote UE establishes a PC5 Relay RLC channel for relaying of SRB1 towards the L2 U2N Remote/Relay UE over PC5.
4. The RRCSetupComplete message is sent by the L2 U2N Remote UE to the gNB via the L2 U2N Relay UE using SRB1 relaying channel over PC5 and SRB1 relaying channel configured to the L2 U2N Relay UE over Uu. Then the L2 U2N Remote UE is as in RRC_CONNECTED with the gNB.
5. The L2 U2N Remote UE and gNB establish security following the Uu security mode procedure and the security messages are forwarded through the L2 U2N Relay UE.
6. The gNB sends an RRCReconfiguration message to the L2 U2N Remote UE via the L2 U2N Relay UE, to setup the end-to-end SRB2/DRBs of the L2 U2N Remote UE. The L2 U2N Remote UE sends an RRCReconfigurationComplete message to the gNB via the L2 U2N Relay UE as a response. In addition, the gNB may configure additional Uu Relay RLC channels between the gNB and L2 U2N Relay UE, and PC5 Relay RLC channels between L2 U2N Relay UE and L2 U2N Remote UE for the relaying traffic.
   [ . . . ]

### 16.12.6 Service Continuity for L2 U2N Relay

### 16.12.6.0 General

The service continuity procedure is applicable only for the mobility cases of path switch from indirect to direct path, and from direct to indirect path when the L2 U2N Remote UE and L2 U2N Relay UE belong to the same gNB.
16.12.6.1 Switching from Indirect to Direct Path
For service continuity of L2 U2N Relay, the following procedure is used, in case of L2 U2N Remote UE switching to direct path:

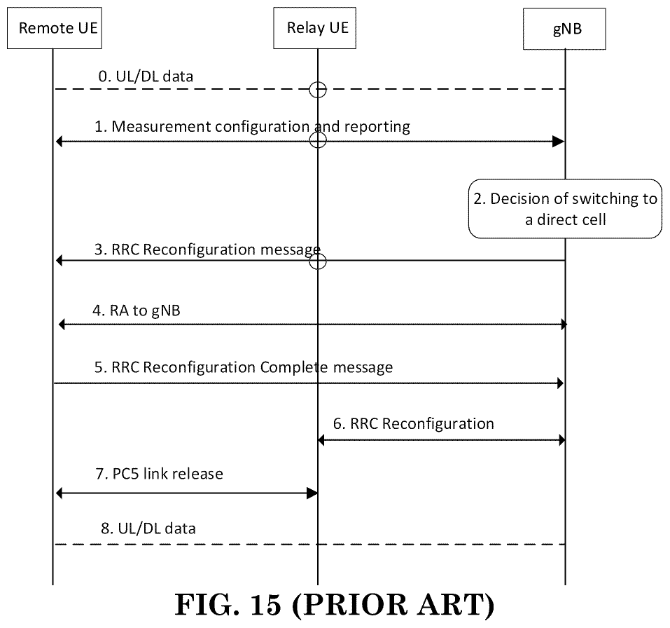

### FIG. 16.12.6.1-1 of 3GPP TS 38.300 V17.5.0, Entitled “Procedure for L2 U2N Remote UE Switching to Direct Uu Cell”, is Reproduced as FIG. 15

1. The Uu measurement configuration and measurement report signalling procedures are performed to evaluate both relay link measurement and Uu link measurement. The measurement results from L2 U2N Remote UE are reported when configured measurement reporting criteria are met. The sidelink relay measurement report shall include at least L2 U2N Relay UE's source L2 ID, serving cell ID (i.e., NCGI/NCI), and sidelink measurement quantity result. The sidelink measurement quantity can be SL-RSRP of the serving L2 U2N Relay UE, and if SL-RSRP is not available, SD-RSRP is used.
2. The gNB decides to switch the L2 U2N Remote UE onto direct Uu path.
3. The gNB sends the RRCReconfiguration message to the L2 U2N Remote UE. The L2 U2N Remote UE stops User Plane and Control Plane transmission via the L2 U2N Relay UE after reception of the RRCReconfiguration message with the path switch configuration.
4. The L2 U2N Remote UE synchronizes with the gNB and performs Random Access.
5. The UE (i.e., L2 U2N Remote UE in previous steps) sends the RRCReconfigurationComplete message to the gNB via the direct path, using the configuration provided in the RRCReconfiguration message. From this step, the UE (i.e., L2 U2N Remote UE in previous steps) uses the RRC connection via the direct path to the gNB.
6. The gNB sends the RRCReconfiguration message to the L2 U2N Relay UE to reconfigure the connection between the L2 U2N Relay UE and the gNB. The RRCReconfiguration message to the L2 U2N Relay UE can be sent any time after step 3 based on gNB implementation (e.g., to release Uu Relay RLC Channel and PC5 Relay RLC channel configuration for relaying, and bearer mapping configuration related to the L2 U2N Remote UE).
7. Either L2 U2N Relay UE or L2 U2N Remote UE's AS layer indicates upper layers to release PC5 unicast link after receiving the RRCReconfiguration message from the gNB. The timing to execute link release is up to UE implementation.
8. The data path is switched from indirect path to direct path between the UE (i.e., previous L2 U2N Remote UE) and the gNB. The PDCP re-establishment or PDCP data recovery in uplink is performed by the UE (i.e., previous L2 U2N Remote UE) for lossless delivery during path switch if gNB configures it.
NOTE: Step 8 can be executed any time after step 4. Step 8 is independent of step 6 and step 7.
   16.12.6.2 Switching from Direct to Indirect Path
   The gNB can select a L2 U2N Relay UE in any RRC state i.e., RRC_IDLE, RRC_INACTIVE, or RRC_CONNECTED, as a target L2 U2N Relay UE for direct to indirect path switch.
   For service continuity of L2 U2N Remote UE, the following procedure is used, in case of the L2 U2N Remote UE switching to indirect path via a L2 U2N Relay UE in RRC_CONNECTED:

### FIG. 16.12.6.2-1 of 3GPP TS 38.300 V17.5.0, Entitled “Procedure for L2 U2N Remote UE Switching to Indirect Path Via a L2 U2N Relay UE in RRC_CONNECTED”, is Reproduced as FIG. 16

1. The L2 U2N Remote UE reports one or multiple candidate L2 U2N Relay UE(s) and Uu measurements, after it measures/discovers the candidate L2 U2N Relay UE(s):
   The L2 U2N Remote UE filters the appropriate L2 U2N Relay UE(s) according to relay selection criteria before reporting. The L2 U2N Remote UE shall report only the L2 U2N Relay UE candidate(s) that fulfil the higher layer criteria;
   The reporting includes at least a L2 U2N Relay UE ID, a L2 U2N Relay UE's serving cell ID, and a sidelink measurement quantity information. SD-RSRP is used as sidelink measurement quantity.
2. The gNB decides to switch the L2 U2N Remote UE to a target L2 U2N Relay UE. Then the gNB sends an RRCReconfiguration message to the target L2 U2N Relay UE, which includes at least the L2 U2N Remote UE's local ID and L2 ID, Uu Relay RLC channel and PC5 Relay RLC channel configuration for relaying, and bearer mapping configuration.
3. The gNB sends the RRCReconfiguration message to the L2 U2N Remote UE. The RRCReconfiguration message includes at least the L2 U2N Relay UE ID, Remote UE's local ID, PC5 Relay RLC channel configuration for relay traffic and the associated end-to-end Uu radio bearer(s). The L2 U2N Remote UE stops User Plane and Control Plane transmission over the direct path after reception of the RRCReconfiguration message from the gNB.
4. The L2 U2N Remote UE establishes PC5 RRC connection with target L2 U2N Relay UE.
5. The L2 U2N Remote UE completes the path switch procedure by sending the RRCReconfigurationComplete message to the gNB via the L2 U2N Relay UE.
6. The data path is switched from direct path to indirect path between the L2 U2N Remote UE and the gNB.
   In case the selected L2 U2N Relay UE for direct to indirect path switch is in RRC_IDLE or RRC_INACTIVE, after receiving the path switch command, the L2 U2N Remote UE establishes a PC5 link with the L2 U2N Relay UE and sends the RRCReconfigurationComplete message via the L2 U2N Relay UE, which triggers the L2 U2N Relay UE to enter RRC_CONNECTED state. The procedure for L2 U2N Remote UE switching to indirect path in FIG. 16.12.6.2-1 can be also applied for the case that the selected L2 U2N Relay UE for direct to indirect path switch is in RRC IDLE or RRC_INACTIVE with the exception that the RRCReconfiguration message is sent from the gNB to the L2 U2N Relay UE after the L2 U2N Relay UE enters RRC_CONNECTED state, which happens during step 5.

3GPP TS 22.261 specifies connectivity models and KPIs for UE to network relaying in 5G system as follows:

### 6.9 Connectivity Models

### 6.9.1 Description

The UE (remote UE) can connect to the network directly (direct network connection), connect using another UE as a relay UE (indirect network connection), or connect using both direct and indirect connections. Relay UEs can be used in many different scenarios and verticals (inHome, SmartFarming, SmartFactories, Public Safety and others). In these cases, the use of relays UEs can be used to improve the energy efficiency and coverage of the system.
Remote UEs can be anything from simple wearables, such as sensors embedded in clothing, to a more sophisticated wearable UE monitoring biometrics. They can also be non-wearable UEs that communicate in a Personal Area Network such as a set of home appliances (e.g. smart thermostat and entry key), or the electronic UEs in an office setting (e.g. smart printers), or a smart flower pot that can be remotely activated to water the plant.
When a remote UE is attempting to establish an indirect network connection, there might be several relay UEs that are available in proximity and supporting selection procedures of an appropriate relay UE among the available relay UEs is needed.
Indirect network connection covers the use of relay UEs for connecting a remote UE to the 3GPP network. There can be one or more relay UE(s) (more than one hop) between the network and the remote UE.
A ProSe UE-to-UE Relay can also be used to connect two remote Public Safety UEs using direct device connection. There can be one or more ProSe UE-to-UE Relay(s) (more than one hop) between the two remote Public Safety UEs.

### 6.9.2 Requirements

The following set of requirements complement the requirements listed in 3GPP TS 22.278 [5], clauses 7B and 7C.

### 6.9.2.1 General

The 5G system shall support the relaying of traffic between a remote UE and a gNB using one or more relay UEs.
The 5G system shall support same traffic flow of a remote UE to be relayed via different indirect network connection paths.
The 5G system shall support different traffic flows of a remote UE to be relayed via different indirect network connection paths.
The connection between a remote UE and a relay UE shall be able to use 3GPP RAT or non-3GPP RAT and use licensed or unlicensed band.
The connection between a remote UE and a relay UE shall be able to use fixed broadband technology.
The 5G system shall support indirect network connection mode in a VPLMN when a remote UE and a relay UE subscribe to different PLMNs and both PLMNs have a roaming agreement with the VPLMN.
The 5G system shall be able to support a UE using simultaneous indirect and direct network connection mode.
The network operator shall be able to define the maximum number of hops supported in their networks when using relay UEs.
The 5G system shall be able to manage communication between a remote UE and the 5G network across multi-path indirect network connections.

### 6.9.2.2 Services and Service Continuity

A 5G system shall be able to support all types of traffic e.g. voice, data, IoT small data, multimedia, MCX for indirect network connection mode.
The 5G system shall be able to support QoS for a user traffic session between the remote UE and the network using 3GPP access technology.
The 5G system shall be able to provide indication to a remote UE (alternatively, an authorized user) on the quality of currently available indirect network connection paths.
The 5G system shall be able to maintain service continuity of indirect network connection for a remote UE when the communication path to the network changes (i.e. change of one or more of the relay UEs, change of the gNB).
NOTE: It does not apply to a traffic flow of a remote UE using different indirect network connection paths.

### 6.9.2.3 Permission and Authorization

The 5G system shall enable the network operator to authorize a UE to use indirect network connection. The authorization shall be able to be restricted to using only relay UEs belonging to the same network operator. The authorization shall be able to be restricted to only relay UEs belonging to the same application layer group.
The 5G system shall enable the network operator to authorize a UE to relay traffic as relay UE. The authorization shall be able to allow relaying only for remote UEs belonging to the same network operator. The authorization shall be able to allow relaying only for remote UEs belonging to the same application layer group.
The 5G system shall support a mechanism for an end user to provide/revoke permission to an authorized UE to act as a relay UE.
The 5G system shall support a mechanism for an authorized third-party to provide/revoke permission to an authorized UE to act as a relay UE.
The 5G system shall provide a suitable API by which an authorized third-party shall be able to authorize (multiple) UEs under control of the third-party to act as a relay UE or remote UE.
The 5G system shall provide a suitable API by which an authorized third-party shall be able to enable/disable (multiple) UEs under control of the third-party to act as a relay UE or remote UE.

### 6.9.2.4 Relay UE Selection

The 3GPP system shall support selection and reselection of relay UEs based on a combination of different criteria e.g.
the characteristics of the traffic that is intended to be relayed (e.g. expected message frequency and required QoS),
the subscriptions of relay UEs and remote UE,
the capabilities/capacity/coverage when using the relay UE,
the QoS that is achievable by selecting the relay UE,
the power consumption required by relay UE and remote UE,
the pre-paired relay UE,
the 3GPP or non-3GPP access the relay UE uses to connect to the network,
the 3GPP network the relay UE connects to (either directly or indirectly),
the overall optimization of the power consumption/performance of the 3GPP system, or
battery capabilities and battery lifetime of the relay UE and the remote UE.
NOTE: Reselection may be triggered by any dynamic change in the selection criteria, e.g. by the battery of a relay UE getting depleted, a new relay capable UE getting in range, a remote UEs requesting additional resources or higher QoS, etc.

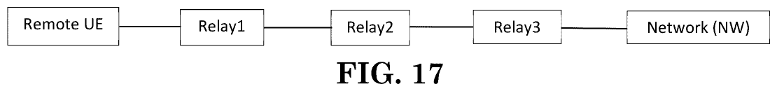

3GPP TS 23.304 introduces the UE-to-Network (U2N) Relay in Release 18. For single hop U2N Relay, a U2N relay may be used to support data communication between a remote UE and the network in case the remote UE cannot communicate with the network directly. A U2N relay needs to establish one PC5 unicast link (or a PC5 Radio Resource Control (RRC) connection) with the remote UE and establish a RRC connection with a network node (e.g. a gNB) to support data communication between the remote UE and the network. According to 3GPP TS 22.261, multi-hop U2N Relay may be supported in Release 19. FIG. 17 illustrates an exemplary 3-hop U2N Relay. And, the network operator shall be able to define the maximum number of hops supported in their networks when using relay UEs.

Considering that the more hops used, the more delay induced, it is not appropriate for the network to configure one value of the maximum number of hops for services with different QoS requirements. Therefore, it is beneficial for the network to configure the maximum number of hops based on services. For example, the network may provide the maximum number of hop for each (ProSe) Relay Service Code (RSC) to a relay UE so as to limit the maximum number of hops used for multi-hop U2N Relay, where a RSC indicates the connectivity service the U2N Relay provides to the Remote UE. Alternatively, the network may provide the mapping of maximum number of hops to (ProSe) RSCs to a relay UE. In one embodiment, each RSC may be associated with one or multiple PDU sessions.

As described in 3GPP TS 23.304, a remote UE may perform a discovery procedure to find a U2N relay and then establish a PC5 unicast link with the U2N relay so as to access the network via the U2N relay. According to 3GPP TS 38.300, a U2N Relay UE can perform Relay discovery message transmission and may monitor the sidelink for Relay discovery message while in RRC_IDLE, RRC_INACTIVE or RRC_CONNECTED. In other words, a U2N Relay UE should be in-coverage (IC) of a network so as to perform Relay discovery message transmission and an out-of-coverage (OOC) U2N Relay UE is not allowed to perform Relay discovery message transmission because a remote UE cannot access the network via an OOC U2N Relay UE.

To support multi-hop U2N Relay, there is no need for all relays involved in the multi-hop U2N Relay to be in-coverage (IC) of the network. Taking FIG. 17 for example, it is sufficient for Relay3 to be in-coverage (IC) and other relays (i.e. Relay1 and Relay2) may be out-of-coverage (OOC). To allow the remote UE to find Relay3 (which is an IC relay), Relay3 may initiate a UE-to-Network Relay Discovery with Model A by transmitting or broadcasting a U2N Relay Discovery Announcement message including an accumulated number of hops of 1. When receiving the U2N Relay Discovery Announcement message from Relay3, Relay2 may transmit or broadcast a new U2N Relay Discovery Announcement message including an accumulated number of hops of 2. Similarly, Relay1 may transmit or broadcast another U2N Relay Discovery Announcement message including an accumulated number of hops of 3 in response to reception of the U2N Relay Discovery Announcement message from Relay2. After receiving the U2N Relay Discovery Announcement message from Relay1, the remote UE may then establish a PC5 unicast link (or a PC5 RRC connection) with Relay1. A PC5 unicast link between Relay1 and Relay2 and a PC5 unicast link between Relay2 and Relay3 may also be established so that the remote UE can access the network via Relay1, Relay2, and Relay3. In this example, it is assumed the maximum number of hops is greater than 3.

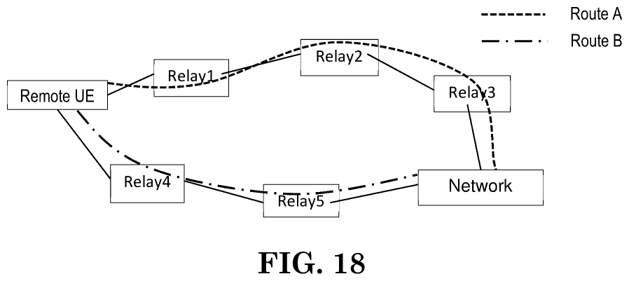

FIG. 18 illustrates an exemplary multi-route UE-to-Network Relay. As shown in FIG. 18, there may be multiple routes for the remote UE to reach the network via different relay UEs. Route A has 3 hops and Route B has 2 hops, respectively. In this situation, it is beneficial in terms of transfer delay for the remote UE to take the accumulated number of hops into consideration for relay UE (or route) selection. For example, the remote UE may select Relay4 (i.e. Route B) for communicating with the network. In other words, the remote UE may select a relay UE indicating a less (or smaller) accumulated number of hops, via which the remote UE can connect to the network. The remote UE may then transmit a Direct Communication Request message to the selected relay UE for establishing a PC5 unicast link (or a PC5 RRC connection) with the selected relay UE. Other factor like signal strength (e.g. RSRP) with relay UE may also be taken into consideration for relay UE selection. After the PC5 unicast links (or PC5 RRC connections) between the remote UE and Relay4 and between Relay4 and Relay5 have been established, the remote UE may then establish a RRC connection with the network via Relay4 and Relay5. This is applicable to a case where a remote UE is initially out of network coverage (OOC) and tries to discover relay UEs for connecting with the network.

When a remote UE initiates a UE-to-Network Relay Discovery with Model B to find an in-coverage relay, the remote UE may transmit or broadcast a U2N Relay Discovery Solicitation message. When receiving the U2N Relay Discovery Solicitation message from the remote UE, a relay UE may transmit or broadcast a new U2N Relay Discovery Solicitation message including an accumulated number of hops of 1 so as to realize the limitation of maximum number of hops configured by the network. The following relay UEs may also transmit or broadcast other U2N Relay Discovery Solicitation messages including an increased accumulated number of hops until the maximum number of hops has been reached or when the relay UE is in coverage (IC) of a network. For example, when receiving a U2N Relay Discovery Solicitation message from other relay UE, the relay UE may reply with a new U2N Relay Discovery Response message if the relay UE is in coverage (IC) of a network. Otherwise, it may transmit or broadcast another U2N Relay Discovery Solicitation message if the relay UE is out of coverage (OOC) of the network and the maximum number of hops has not been reached (i.e. the accumulated number of hops, included in the received U2N Relay Discovery Solicitation message, plus 1 is less or smaller than the maximum number of hops).

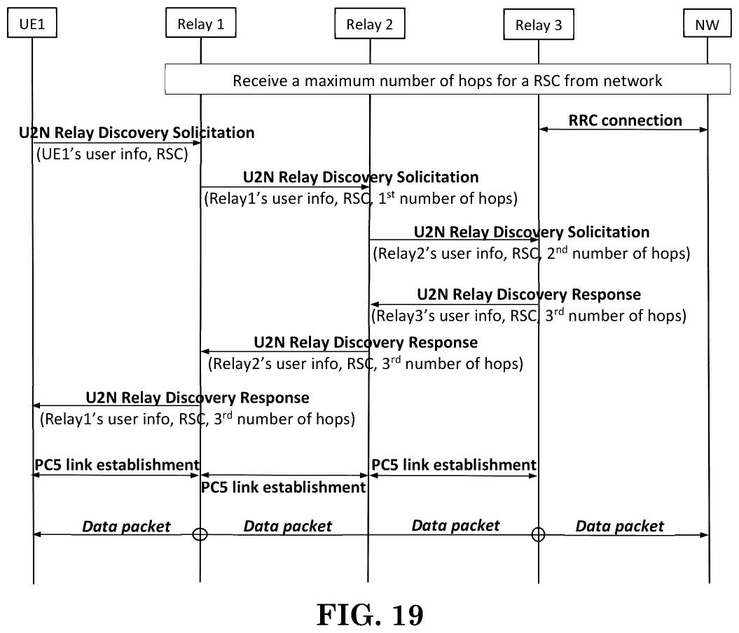

As discussed above, the remote UE may select a relay route/path for accessing the network based on the accumulated number of hops associated with each relay route/path. To support this, the in-coverage (IC) relay UE needs to include the final accumulated number of hops in the U2N Relay Discovery Response message. Those intermediate relay UEs may also include the final accumulated number of hops in a new U2N Relay Discovery Response message when receiving the U2N Relay Discovery Response message from a relay UE. As a result, the remote UE can receive the final accumulated number of hops in a U2N Relay Discovery Response message sent from the relay UE in proximity. FIG. 19 illustrates an example of Multi-hop UE-to-Network Relay Discovery with Model B. The final accumulated number of hops is 3 in the example shown in FIG. 19.

Alternatively, the IC relay UE may (re-)initialize the accumulated number of hops with 1 and include it in the U2N Relay Discovery Response message. Each subsequent relay UE may increase the received accumulated number of hops by 1. As a result, the remote UE would also receive the final accumulated number of hops of 3 from the relay UE in proximity.

The above mentioned U2N Relay Discovery Solicitation messages or U2N Relay Discovery Response messages may include user info ID of the remote UE in case there may be multiple UE-to-Network Relay Discovery procedures ongoing during the same period of time.

To support switching between direct path and indirect path, a remote UE needs to report measurement results of candidate relay UEs to gNB so that the gNB can select a target relay UE for path switching. A measurement report message may include at least a L2 U2N Relay UE ID, a L2 U2N Relay UE's serving cell ID (e.g., NCGI/NCI), and a sidelink measurement quantity information (e.g. RSRP).

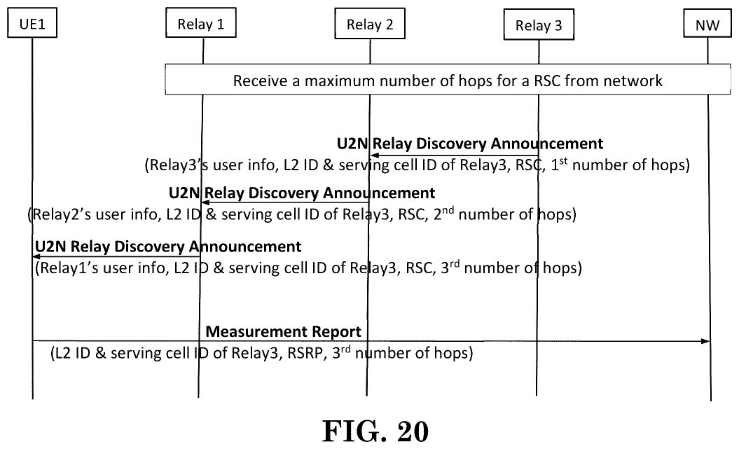

FIG. 20 illustrates an exemplary remote UE measurement reporting with Model A. In case of multi-hop U2N Relay as shown in FIG. 20, it is supposed that the measurement may be performed on the relay UE (e.g. Relay 1) in proximity of the remote UE, while the L2 ID and the serving cell ID could belong to the relay UE connecting with the gNB (e.g. Relay 3). Therefore, Relay 3 needs to send its L2 ID and serving cell ID to the remote UE via intermediate relay UEs (e.g. Relay 1 and Relay 2) during the discovery procedure. Relay 3 may send its L2 ID and serving cell ID in a U2N Relay discovery message (e.g. a U2N Relay Discovery Announcement message for Model A or a U2N Relay Discovery Response message for Model B). It is also feasible for Relay 3 to send these two information to remote UE using other PC5-S message or PC5-RRC message after the discovery procedure. Alternatively, the L2 ID and the serving cell ID may be transmitted in two different messages. For example, the serving cell ID may be transmitted in a U2N Relay Discovery Announcement message or a U2N Relay Discovery Response message and the L2 ID may be transmitted in a Relay Discovery Additional Information message or a PC5-RRC message. Also, the L2 ID may be forwarded to the remote UE by intermediate relay UEs in another Relay Discovery Additional Information message or another PC5-RRC message. Besides, another identity (e.g. User Info ID or C-RNTI) of Relay3 may be used to replace the L2 ID. Preferably, the remote UE may send an Additional Parameters Announcement Request to Relay3 via the intermediate relays (i.e. Relay1 and Relay2) for requesting the L2 ID of Relay3.

In general, measurement results of multiple candidate relay UEs may be reported by the remote UE and thus there may be multiple entries of candidate relay UE information. Each entry may include a measurement result, a Layer-2 ID of the candidate relay UE, and an ID of a serving cell of the candidate relay UE. After receiving the measurement report from the remote UE, the gNB may then determine a target relay UE for path switching and send a RRC Reconfiguration message indicating the target relay UE to the remote UE. In one embodiment, the RRC Reconfiguration message may include information indicating the target relay UE (e.g. an entry index or a L2 ID of the target relay UE), a local ID for the remote UE, PC5 Relay RLC channel configuration for relay traffic, and/or the associated end-to-end Uu radio bearer(s). The remote UE may then connect with the target relay UE and the intermediate relay UEs in the concerned relay path for switching to the indirect path. Also, the gNB needs to send another RRC Reconfiguration message to inform the target relay UE of path switching. In one embodiment, the RRC Reconfiguration message may include the remote UE's L2 ID, a local ID for the remote UE, Uu Relay RLC channel and PC5 Relay RLC channel configuration for relaying, and/or bearer mapping configuration.

On the other aspect, it is beneficial in terms of QoS requirement for gNB to take the (accumulated) number of hops involved in multi-hop U2N Relay into consideration when selecting the target relay UE for the remote UE. To realize this, there is a need for the remote UE to include the (accumulated) number of hops involved in multi-hop U2N Relay and associated with each candidate relay UE in the measurement report message sent to gNB.

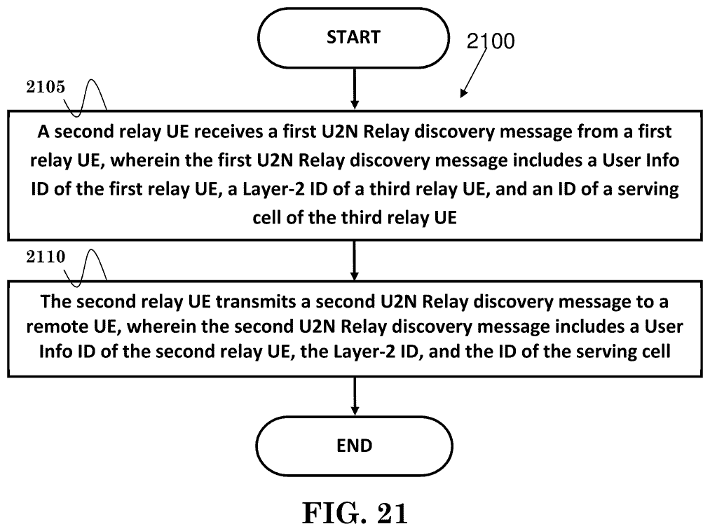

FIG. 21 is a flow chart 2100 of a method for UE-to-Network Relay discovery. In step 2105, a second relay UE receives a first U2N Relay discovery message from a first relay UE, wherein the first U2N Relay discovery message includes a User Info Identity (ID) of the first relay UE, a Layer-2 ID of a third relay UE, and an ID of a serving cell of the third relay UE. In step 2110, the second relay UE transmits a second U2N Relay discovery message to a remote UE, wherein the second U2N Relay discovery message includes a User Info ID of the second relay UE, the Layer-2 ID, and the ID of the serving cell.

In one embodiment, the third relay UE may be same as or different from the first relay UE. In case the third relay UE is same as the first relay UE, it means that there are two U2N relays between the remote UE and the network (in the relay path).

In one embodiment, the first U2N Relay discovery message may include a first accumulated number of hops. The second U2N Relay discovery message may include a second accumulated number of hops. The second accumulated number of hops may be equal to the first accumulated number of hops plus 1.

In one embodiment, the first U2N Relay discovery message may include a User Info ID of the remote UE and/or a Relay Service Code (RSC). The second U2N Relay discovery message may include the User Info ID of the remote UE and/or the RSC.

In one embodiment, the first U2N Relay discovery message or the second U2N Relay discovery message may be a U2N Relay Discovery Announcement message. The first U2N Relay discovery message or the second U2N Relay discovery message may be a U2N Relay Discovery Response message.

Referring back to FIGS. 3 and 4, in one exemplary embodiment from the perspective of a second relay UE. The second relay UE 300 includes a program code 312 stored in the memory 310. The CPU 308 could execute program code 312 to enable the second relay UE (i) to receive a first U2N Relay discovery message from a first relay UE, wherein the first U2N Relay discovery message includes a User Info ID of the first relay UE, a Layer-2 ID of a third relay UE, and an ID of a serving cell of the third relay UE, and (ii) to transmits a second U2N Relay discovery message to a remote UE, wherein the second U2N Relay discovery message includes a User Info ID of the second relay UE, the Layer-2 ID, and the ID of the serving cell. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for UE-to-Network Relay (U2N) discovery, comprising:
a second relay UE receives a first U2N Relay discovery message from a first relay UE, wherein the first U2N Relay discovery message includes a User Info Identity (ID) of the first relay UE, a Layer-2 ID of a third relay UE, and an ID of a serving cell of the third relay UE; and
the second relay UE transmits a second U2N Relay discovery message to a remote UE, wherein the second U2N Relay discovery message includes a User Info ID of the second relay UE, the Layer-2 ID, and the ID of the serving cell.

2. The method of claim 1, wherein the third relay UE is same as the first relay UE.

3. The method of claim 1, wherein the third relay UE is different from the first relay UE.

4. The method of claim 1, wherein the first U2N Relay discovery message includes a first accumulated number of hops.

5. The method of claim 4, wherein the second U2N Relay discovery message includes a second accumulated number of hops.

6. The method of claim 5, wherein the second accumulated number of hops is equal to the first accumulated number of hops plus 1.

7. The method of claim 1, wherein the first U2N Relay discovery message includes a User Info ID of the remote UE and/or a Relay Service Code (RSC).

8. The method of claim 7, wherein the second U2N Relay discovery message includes the User Info ID of the remote UE and/or the RSC.

9. The method of claim 1, wherein the first U2N Relay discovery message or the second U2N Relay discovery message is a U2N Relay Discovery Announcement message.

10. The method of claim 1, wherein the first U2N Relay discovery message or the second U2N Relay discovery message is a U2N Relay Discovery Response message.

11. A second relay User Equipment (UE) for UE-to-Network Relay (U2N) discovery, comprising:
a control circuit;
a processor installed in the control circuit; and
a memory installed in the control circuit and operatively coupled to the processor;
wherein the processor is configured to execute a program code stored in the memory to:
receive a first U2N Relay discovery message from a first relay UE, wherein the first U2N Relay discovery message includes a User Info Identity (ID) of the first relay UE, a Layer-2 ID of a third relay UE, and an ID of a serving cell of the third relay UE; and
transmit a second U2N Relay discovery message to a remote UE, wherein the second U2N Relay discovery message includes a User Info ID of the second relay UE, the Layer-2 ID, and the ID of the serving cell.

12. The second relay UE of claim 11, wherein the third relay UE is same as the first relay UE.

13. The second relay UE of claim 11, wherein the third relay UE is different from the first relay UE.

14. The second relay UE of claim 11, wherein the first U2N Relay discovery message includes a first accumulated number of hops.

15. The second relay UE of claim 14, wherein the second U2N Relay discovery message includes a second accumulated number of hops.

16. The second relay UE of claim 15, wherein the second accumulated number of hops is equal to the first accumulated number of hops plus 1.

17. The second relay UE of claim 11, wherein the first U2N Relay discovery message includes a User Info ID of the remote UE and/or a Relay Service Code (RSC).

18. The second relay UE of claim 17, wherein the second U2N Relay discovery message includes the User Info ID of the remote UE and/or the RSC.

19. The second relay UE of claim 11, wherein the first U2N Relay discovery message or the second U2N Relay discovery message is a U2N Relay Discovery Announcement message.

20. The second relay UE of claim 11, wherein the first U2N Relay discovery message or the second U2N Relay discovery message is a U2N Relay Discovery Response message.
